(19) United States
(12) Patent Application Publication
(10) Pub. No.: US 2016/0282977 A1
(43) Pub. Date: Sep. 29, 2016

(54) CAPACITIVE SENSING ASSEMBLY INCLUDING A THIN FILM PLASTIC

(71) Applicant: Synaptics Inc., San Jose, CA (US)

(72) Inventors: VanDee MOUA, Spokane, WA (US); Peter BOKMA, Coeur d'Alene, ID (US)

(21) Appl. No.: 14/665,525

(22) Filed: Mar. 23, 2015

(51) Int. Cl. G06F 3/044; B29C 45/14; G06K 9/00

(52) U.S. Cl. CPC G06F 3/044; G06K 9/0002; B29C 45/14311; B29L 2031/3475

(57) ABSTRACT

A capacitive sensing stackup is disclosed that includes: a thin film plastic; an injection molded plastic component bonded to the thin film plastic, wherein the injection molded plastic component forms a cavity bounded by the injection molded plastic and the thin film plastic that exposes at least a portion of the thin film plastic; and, a capacitive sensor assembly including a plurality of sensor electrodes configured to be driven with a capacitive sensing signal, wherein the capacitive sensor assembly is coupled to the thin film plastic in the cavity formed by the injection molded plastic component.

### FIELD

This disclosure relates generally to the field of capacitive sensing and, more specifically, to a capacitive sensing assembly including a thin film plastic.

### BACKGROUND

Since its inception, capacitive sensing technology has aided biometric identification and authentication processes. In many cases, a single biometric marker can be used to uniquely identify an individual in a manner that cannot be easily replicated or imitated. The ability to capture and store biometric data in a digital file of minimal size has yielded immense benefits in fields such as law enforcement, forensics, and information security.

However, the widespread adoption of capacitive sensing technology in a broad range of applications has faced a number of obstacles. Among these obstacles is the need for a separate and distinct apparatus for capturing the biometric data, typically referred to as a sensor. As handheld devices begin to take on a greater range of functionality and more widespread use, engineers and designers of such devices are constantly seeking ways to maximize sophistication and ease of use while minimizing size and cost. Typically, such devices incorporate only those input/output components that are deemed to be essential to core functionality, e.g., a display screen and a limited set of buttons. As such, placing the sensor within electronic devices has been challenging, given the limited amount of space for additional components.

### SUMMARY

One embodiment provides a capacitive sensing stackup, including: a thin film plastic; an injection molded plastic component bonded to the thin film plastic, wherein the injection molded plastic component forms a cavity bounded by the injection molded plastic and the thin film plastic that exposes at least a portion of the thin film plastic; and, a capacitive sensor assembly including a plurality of sensor electrodes configured to be driven with a capacitive sensing signal, wherein the capacitive sensor assembly is coupled to the thin film plastic in the cavity formed by the injection molded plastic component.

Another embodiment provides a method for manufacturing a capacitive sensing stackup for capacitive sensing. The method includes: providing a thin film plastic; injection molding an injection molded plastic component, wherein the injection molded plastic component is bonded to the thin film plastic, and wherein the injection molded plastic component forms a cavity bounded by the injection molded plastic component and the thin film plastic that exposes at least a portion of the thin film plastic; and, securing a capacitive sensor assembly including a plurality of sensor electrodes configured to be driven with a capacitive sensing signal to the thin film plastic, wherein the capacitive sensor assembly is coupled to the thin film plastic in the cavity formed by the injection molded plastic component.

Yet another embodiment provides a mobile computing device that includes a housing body and a capacitive sensing stackup embedded in the housing body. The capacitive sensing stackup include: a thin film plastic, an injection molded plastic component bonded to the thin film plastic, wherein the injection molded plastic component forms a cavity bounded by the injection molded plastic and the thin film plastic that exposes at least a portion of the thin film plastic, and, a capacitive sensor assembly including a plurality of sensor electrodes configured to be driven with a capacitive sensing signal, wherein the capacitive sensor assembly is coupled to the thin film plastic in the cavity formed by the injection molded plastic component.

### BRIEF DESCRIPTION OF THE DRAWINGS

FIG. 1 is a top perspective view of a capacitive sensor and housing adaptable to be incorporated into an electronic device, according to one embodiment of the disclosure.

FIG. 2A is a bottom perspective view of the capacitive sensor and housing of FIG. 1, according to one embodiment of the disclosure.

FIG. 2B is a cross-section view of the capacitive sensor and housing of FIG. 1, according to one embodiment of the disclosure.

FIGS. 3A-3B are block diagrams illustrating various stages of assembling a sensor package and a housing, according to one embodiment of the disclosure.

FIG. 4 is a bottom view of a housing having a cavity that includes two sides formed by the injection molded plastic components, according to one embodiment of the disclosure.

FIG. 5 is a bottom view of a housing having a cavity that includes four sides formed by the injection molded plastic components, according to one embodiment of the disclosure.

FIG. 6 is a method for manufacturing a capacitive sensor stackup for capacitive sensing that includes a thin film plastic, according to one embodiment of the disclosure.

FIG. 7 is a perspective cross-section view of a button for an electronic device, according to one embodiment of the disclosure.

FIG. 8 is a perspective cross-section view of a button for an electronic device that includes a sensor package, according to one embodiment of the disclosure.

FIG. 9 is a perspective cross-section view of a palm rest for an electronic device, according to one embodiment of the disclosure.

FIG. 10 is a perspective cross-section view of a palm rest for an electronic device that includes a sensor package, according to one embodiment of the disclosure.

FIG. 11 is stackup of a COF (chip on flex) circuit that includes a thin film plastic layer, according to one embodiment of the disclosure.

### DETAILED DESCRIPTION

Electronic devices such as mobile phones, tablet devices, and laptop computers often use various forms of very high gloss substrates as the cover of such devices. These substrates are often made of materials such as glass, clear or colored plastic, acrylic, or any other material having high gloss surfaces.

In order to fit a biometric sensor (such as a fingerprint sensor) into the housing of an electronic device, a very high gloss surface can be used on an upper portion of the biometric sensor so as to match the surrounding surfaces of the electronic device in which the biometric sensor is incorporated. Some embodiments of the disclosure utilize IMD (in-mold decoration) manufacturing techniques to provide a top cover over a fingerprint sensor. IMD manufacturing is a process technology by which thin plastic layers are created that normally would not be possible using traditional injection molding. For a fingerprint sensor to function, the material used above the conductive portion of the sensor should be very thin to maintain usable signal-to-noise levels, for example 200 microns or thinner. Some capacitive sensing techniques may be able to successfully operate through a thicker material, but a thinner material usually improves the signal detected by the sensor. An IMD-formed thin plastic layer over a fingerprint sensor protects the sensor from contamination and ingress of fluids. In embodiments where the sensor is integrated into a button of an electronic device, the IMD-formed thin plastic layer can provide decoration so the button is aesthetically pleasing.

In other embodiments, a COF (chip on flex) flex circuit itself can be an IMD layer, as opposed to providing an IMD layer separate from the fingerprint sensor. In these embodiments, the COF would not be bonded to the IMD layer, but rather is a part of the IMD film itself. For example, a sensor that includes copper traces on its top surfaces can be covered with an ink layer that can be color coded to match a customer's requirements. A polyimide (PI) film layer can then be deposited onto the ink layer, forming the IMD film.

As described herein, electronic devices can be configured to include a variety of components and features including, but not limited to, a display, a touch screen, a scratch-resistant cover (e.g., lens), a storage device, a system on a chip, one or more CPU (central processing unit) cores, one or more GPU (graphics processing unit) cores, memory, wireless network connectivity (e.g., 802.11 b/g), Bluetooth® connectivity, a camera, one or more speakers, a battery (e.g., built-in, rechargeable lithium-ion polymer battery), a power connector, among other things. Additionally, electronic devices and electronic device displays can be configured to include, for example, a button or form factor for user interaction (e.g., power on and off, volume change, etc.). Buttons can be provided and integrated in the electronic device housing or be included as part of an electronic device screen.

Biometric sensors can include, for example, a fingerprint sensor, a velocity sensor, a temperature sensor, an iris or retina sensor, among other sensors. An integrated circuit is electrically connected to the biometric sensor. Conductive traces of the biometric sensor can be etched or otherwise formed on an upper side of a substrate. A protective coating is applied to the upper surface of the substrate, over the biometric sensor to provide electrical isolation and mechanical protection of the sensor. Alternatively, conductive traces of the sensor can be formed on a bottom-side of a substrate, where the substrate can act as a protective coating and can be further improved another coating applied to the upper surface.

In the sensor packagings disclosed herein, a biometric sensor, such as a fingerprint sensor, is integrated with an electronic device display or electronic device housing and is positionable on or adjacent to an uppermost surface of the electronic device display or housing such that the fingerprint sensor is within about 250 microns or less of a finger when the finger comes in contact with the uppermost surface of the electronic device. In at least some configurations, the sensor packagings can be configured such that the biometric sensor is configured to be positioned within about 200 microns of a finger, more preferably within 150 microns, still more preferably within 100 microns, or even more preferably within 50 microns of a finger, when the finger comes in contact with the uppermost surface of the electronic device. In at least some configurations, the sensor packagings can be configured such that the biometric sensor is configured to be positioned more than 50 microns away from a finger, more than 100 microns away from the finger, more than 150 microns, and in some configurations more than 200 microns from a finger surface when the finger comes in contact with the uppermost surface of the electronic device. Capacitive sensors may be capable of successfully performing fingerprint detection and authentication through a wide range of material thickness. For example, in certain configurations a capacitive sensor may be able to successfully detect a finger even with 300 or more microns of material between the capacitive sensor and the finger. However, a capacitive sensor usually is more effective in detecting a fingerprint through a low material thickness.

In some configurations, a single chip can be provided that controls one or more of the display, the touch screen and the fingerprint sensing functions. Additionally, the biometric sensor can be incorporated in the electronic device so that the surface of the electronic device incorporating the sensor packagings presented to a user is smooth or substantially smooth. Displays and systems can be configured such that they are integrally formed so that they act in a unified manner or such that the completed electronic device is comprised of a single component.

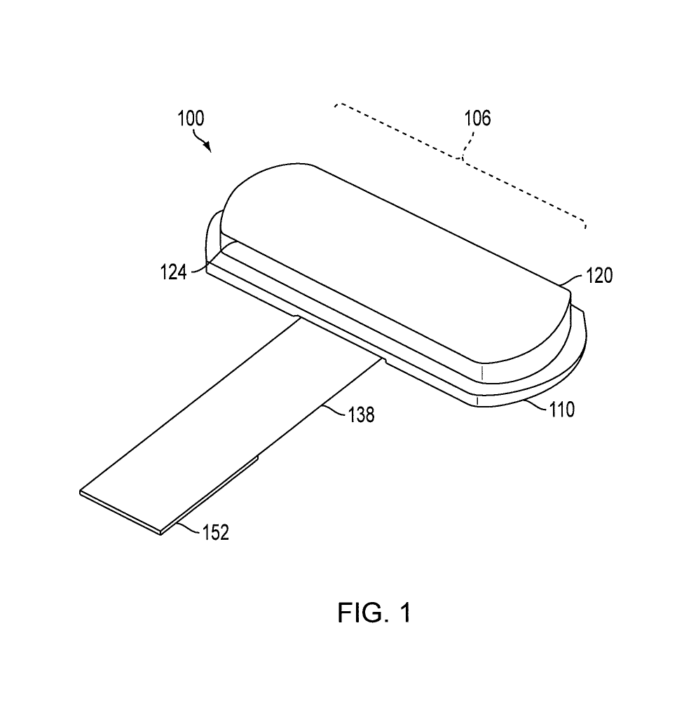

FIG. 1 is a top perspective view of a capacitive sensor 100 and housing 110 adaptable to be incorporated into an electronic device, according to one embodiment of the disclosure. In the embodiment shown, the housing 110 comprises a button from a top perspective view. The housing 110 is configurable to be integrated into an electronic device, such as a mobile phone, having an electronic device or display interface that a user engages with the user's finger. Some example dimensions for the form factor correspond to the nature of the electronic device input. For a rectangular or oval shaped input device, example form factors include: 4 mm×1 mm, 4 mm×4 mm, 5 mm×15 mm, 10 mm×10 mm, and 10 mm×15 mm. Other dimensions can readily be used without departing from the scope of the disclosure. The shape of the housing 110 may be any geometric shape desired, including, but not limited to, round, oval, ovoid, elliptical, square, rectangular, trapezoidal, triangular, etc. Additionally, the size of the housing 110 can be adjusted depending on whether the capacitive sensor 100 is a one-dimensional (1D) sensor or a two-dimensional (2D) sensor.

The housing 110 has a cover layer 120 over a sensor component (not shown in FIG. 1). As described herein, the cover layer 120 may be formed by the IMD manufacturing process and may include an ink layer 124. In some embodiments, the ink layer 124 may comprise paint. An interface area 106, such as a swipe or placement area that would be used for a fingerprint sensor, could be at least a portion of the upper surface of the capacitive sensor 100.

The cover layer 120 is positioned such that it obscures electronic components located within the housing 110. For example, in a touch screen interface, a portion of the interface that is not covered by cover layer 120 can be configured to have a plurality of touch screen sensors. The plurality of touch screen sensors can be any suitable conductor, including a transparent conductor, for example, from a layer of patterned indium tin oxide (ITO), carbon nanotubes, metal nanowires, conductive polymers or fine metal lines (e.g., copper lines). Additionally, a fingerprint sensor can, but need not, be positioned in a location where the cover layer 120 is also present. In another configuration, an aperture can be provided in the cover layer 120 corresponding to all or part of a location where the fingerprint is sensed. The cover layer 120 can be separate from the sensor itself or can be formed integral with the sensor, as described in greater detail herein.

The biometric sensor is connected with one or more conductive traces 138 to a processing system 152. The processing system 152 can be included outside of the housing 110, as shown in FIG. 1, or may be included within or below the housing 110. In some embodiments, the conductive traces 138 are included on a flexible substrate.

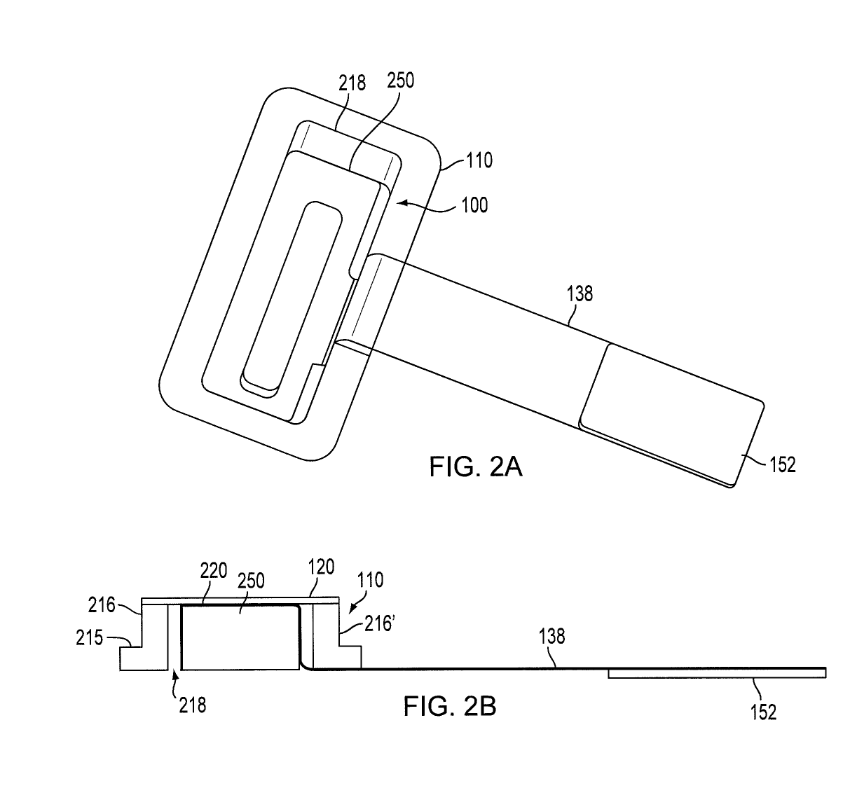

FIG. 2A is a bottom perspective view of the capacitive sensor 100 and housing 110 of FIG. 1, according to one embodiment of the disclosure. FIG. 2B is a cross-section view of the capacitive sensor 100 and housing 110 of FIG. 1, according to one embodiment of the disclosure.

As shown in FIGS. 2A-2B, the capacitive sensor 100 includes a sensor package 250, conductive traces 138, and a processing system 152. The housing 110 includes the cover layer 120, a base 215, and side walls 216, 216′. The cover layer 120, base 215, and side walls 216, 216′ form a cavity 218 into which the sensor package 250 can be positioned. In the example shown in FIGS. 2A-2B, the sensor package 250 is positioned inside the cavity 218 such that an upper portion 220 of the sensor package 250 is directly coupled to the cover layer 120. In some embodiments, the sensor package 250 may be adhesively bonded to the cover layer 120. In other embodiments, the sensor package may be held in place relative to the cover layer 120 by other forces, including being attached to an object at the base of the sensor package. Various other configurations may also be used. As described above, the cover layer 120 may be formed by the IMD manufacturing process. The base 215 and side walls 216, 216′ can be formed by injection molding. Typically, a conventional IMD manufacturing process results in a thin film plastic layer atop a thicker injection molded plastic. The thin film plastic layer can serve to provide decoration that is more visually appealing than the underlying injection molded plastic. In order to produce the configuration described in FIGS. 2A-2B, the IMD process is modified so that, rather than the injection molded plastic being located under the entirety of the cover layer 120 of thin film plastic, a cavity is left where the bottom of the thin film plastic is not adjacent to the injection molded plastic. In this cavity, the sensor package may be placed in order to allow the sensor package to be nearer the location of a finger which the sensor package operates to detect the fingerprint of. That is, by introducing a cavity in which the sensor package is placed, the sensor package detects the finger through the cover layer 120 rather than the cover layer 120 and the injection molded plastic that make up the side walls 216.

One reason for placing the sensor package 250 behind the cover layer 120 rather than positioning the sensor package 250 to directly be in contact with a finger, is that the cover layer provides protection from water, liquids, and other debris that may be harmful to the sensor package. The cover layer 120 can serve to protect the sensor package 250, as well as other circuitry or electronics from damage.

In addition to what is shown in FIGS. 2A-2B, other configurations can be used without departing from the scope of the disclosure. For example, a potting agent can also be provided inside the housing 110 to further protect the sensor package 250 located therein.

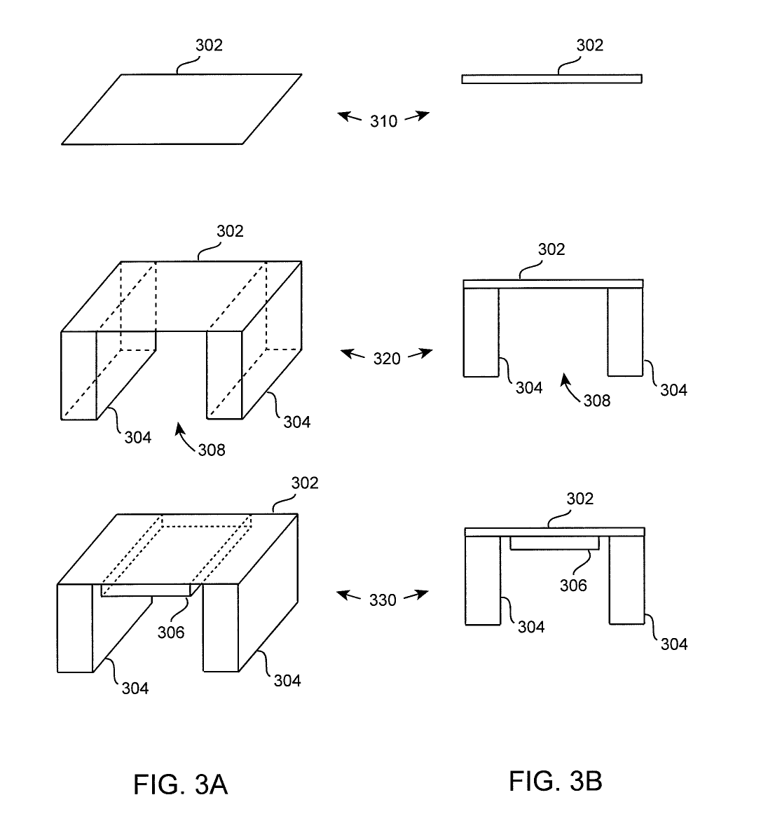

FIGS. 3A-3B are block diagrams illustrating various stages of assembling a sensor package 306 and a housing, according to one embodiment of the disclosure. FIG. 3A is a perspective view. FIG. 3B is a side view.

At stage 310, a thin film plastic layer 302 is provided. In some embodiments, the thin film plastic layer 302 is formed by the IMD manufacturing process. According to some embodiments, IMD is a type of plastic molding process used for decorating plastic surfaces with an abrasion-resistant coat and optionally color. A carrier foil is placed inside an opened mold. The mold can be constructed so that the back side of the carrier foil rests against a flat wall. The carrier foil can be bent, if desired. The carrier foil carries dried ink layers that are to be transferred to a plastic part with the ink facing towards the side of the mold into which plastic is inserted. After the mold is filled with plastic, the ink adheres to the plastic and is removed from mold.

At stage 320, one or more injection molded plastic components 304 are injection molded and bonded to the thin film plastic layer 302. The injection molded plastic components 304 and the thin film plastic layer 302 form a cavity 308 that exposes at least a portion of the thin film plastic layer 302. In one embodiment, the injection molded plastic components 304 are thicker than the thin film plastic layer 302.

At stage 330, a sensor package 306 including a plurality of sensor electrodes configured to be driven with a capacitive sensing signal is coupled to the thin film plastic layer 302 in the cavity 308 formed by the injection molded plastic components 304 and the thin film plastic layer 302.

In some embodiments, an illumination source can be added to the assembly so that light from the illumination source travels through the thin film plastic layer 302. In other words, the assembly may comprise a button that can light up.

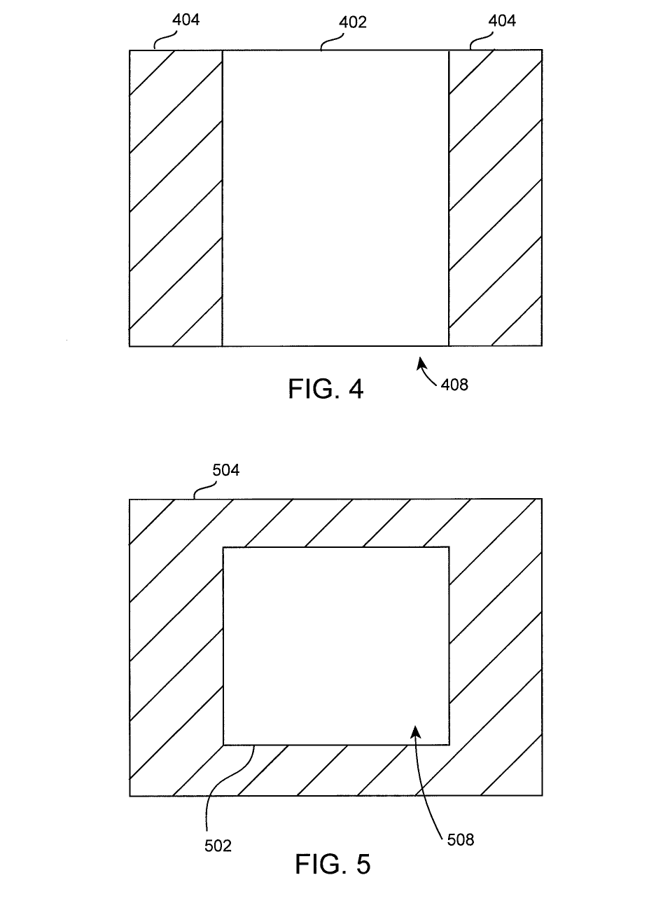

FIG. 4 is a bottom view of a housing having a cavity 408 that includes two sides formed by the injection molded plastic components 404, according to one embodiment of the disclosure. As shown, a thin film plastic layer 402 is exposed in the cavity 408 that includes two sides formed by the injection molded plastic components 404. A sensor package can be inserted into the cavity 408 and coupled to the thin film plastic layer 402.

FIG. 5 is a bottom view of a housing having a cavity 508 that includes four sides formed by the injection molded plastic components 504, according to one embodiment of the disclosure. As shown, a thin film plastic layer 502 is exposed in the cavity 508 that includes four sides formed by the injection molded plastic components 504. A sensor package can be inserted into the cavity 508 and be coupled to the thin film plastic layer 502.

In yet another embodiment, the cavity can include five sides formed by injection molded plastic components. Starting with the embodiment shown in FIG. 5, a sensor package can be inserted into the cavity 508. Once the sensor package is inserted, another side formed by injection molded plastic components can be formed on the bottom side of the sensor package, effectively sealing the sensor package on four sides as shown in FIG. 5, on a top side (i.e., finger sensing side) by the thin film plastic layer, and on a bottom side by an additional wall formed by one or more additional injection molded plastic components.

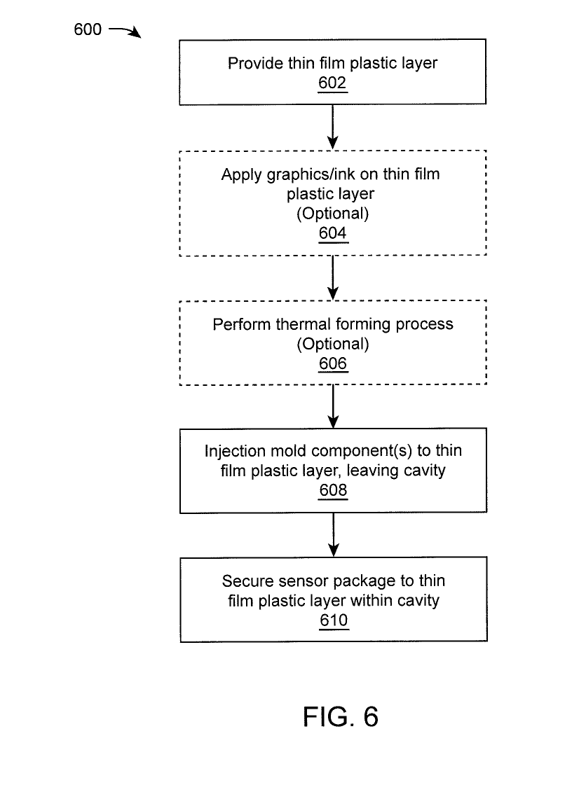

FIG. 6 is a method for manufacturing a capacitive sensor stackup for capacitive sensing that includes a thin film plastic, according to one embodiment of the disclosure. The method 600 begins at step 602, where a thin film plastic layer is provided. In many embodiments, the thin film plastic layer may be flat or curved. In some embodiments, the thin film plastic layer has a thickness of 200 microns or less, preferably 50 microns or less.

At step 604, graphics and/or ink are applied to the thin film plastic layer. In some embodiments, step 604 is optional and is not performed.

At step 606, thermal forming of the thin film plastic layer is performed. Thermal forming forms the thin film plastic layer into a desired shape. For example, the thin film plastic may be formed according the surface of a button or surrounding features. In some embodiments, step 606 is optional and is not performed.

At step 608, one or more injection molded plastic components are injection molded and bonded to the thin film plastic layer. The injection molded plastic components and the thin film plastic layer form a cavity that exposes at least a portion of the thin film plastic layer.

At step 610, a sensor package is secured to the thin film plastic layer within the cavity. In some embodiments, the sensor package is secured to the thin film plastic layer with an adhesive. In other embodiments, if the sensor package is appropriately sized, the sensor package is secured to the thin film plastic layer via friction between the sensor package and the one or more injection molded plastic components.

While certain steps were specifically mentioned as optional, it should be appreciated that the steps of FIG. 6 describe some possible embodiments. In other embodiments, a variety of steps may omitted or occur in a different order. For example, step 610 may occur prior to step 606 so that the thermal forming forms the thin film plastic layer to the sensor package.

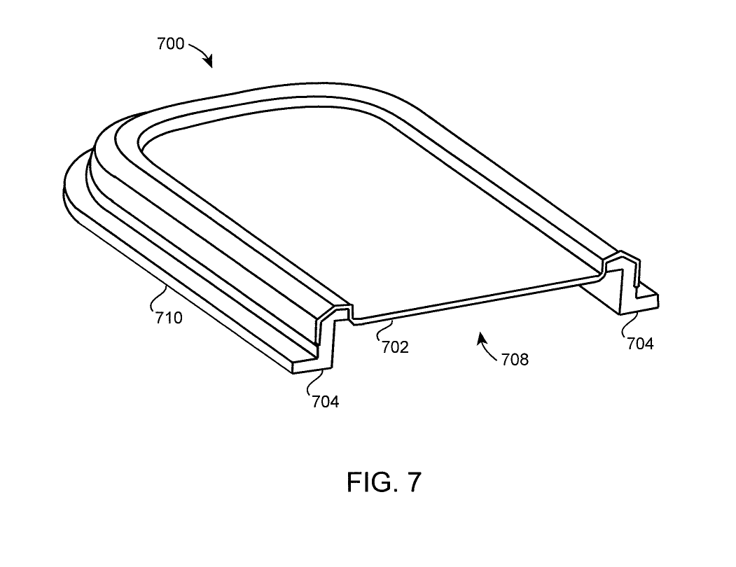

FIG. 7 is a perspective cross-section view of a button 700 for an electronic device, according to one embodiment of the disclosure. As shown, the button 700 includes a thin film plastic layer 702 and injection molded plastic components 704. The thin film plastic layer 702 and injection molded plastic components 704 form a cavity 708 into which a sensor package can be inserted. In the example shown in FIG. 7, the injection molded plastic components 704 include a bezel 710, allowing the button 700 to be held in place within a housing body of an electronic device.

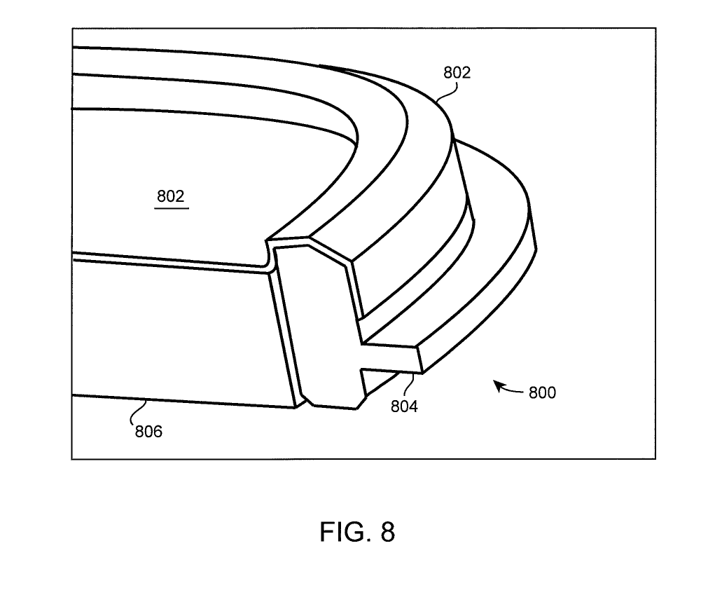

FIG. 8 is a perspective cross-section view of a button 800 for an electronic device that includes a sensor package 806, according to one embodiment of the disclosure. As shown, the button 800 includes a thin film plastic layer 802 and injection molded plastic components 804. The thin film plastic layer 802 and the injection molded plastic components 804 form a cavity into which a sensor package 806 is inserted. As shown in the example in FIG. 8, the sensor package 806 is coupled to the thin film plastic layer 802. Sensor electrodes can be included on the portion of the sensor package 806 coupled to the thin film plastic layer 802 to be driven with a capacitive sensing signal.

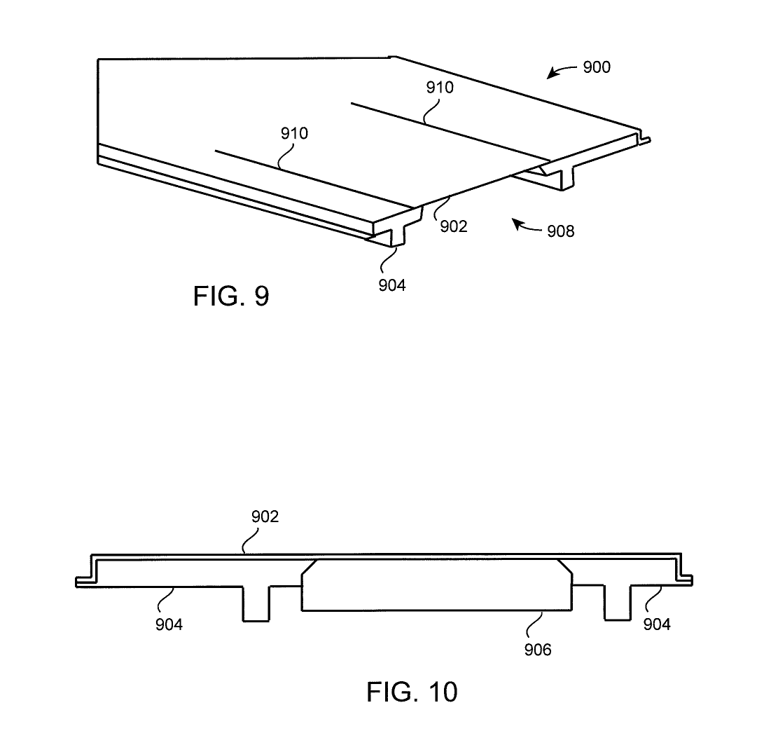

FIG. 9 is a perspective cross-section view of a palm rest 900 for an electronic device, according to one embodiment of the disclosure. In some embodiments, the palm rest 900 is a portion of an electronic device, such as a laptop computer, on which a user's palm rests while typing on a keyboard of the electronic device. In laptop computers that include a keyboard and trackpad, the palm rest is the portion of the laptop computer on either side of the trackpad where a user's palm rests when typing on the keyboard.

As shown in FIG. 9, the palm rest 900 includes a thin film plastic layer 902 and injection molded plastic components 904. The thin film plastic layer 902 and injection molded plastic components 904 form a cavity 908 into which a sensor package can be inserted. Lines 910 are shown on a top side of the thin film plastic layer 902 to indicate that a sensor package is included on the bottom side of the thin film plastic layer 902 in the area between the lines. Such an indication may be useful so that a user knows the location of the capacitive sensor for detecting the user's fingerprint. In other configurations, no visual indication may be present on the top side of the thin film plastic layer 902 to indicate that a sensor package is included on the bottom side of the thin film plastic layer 902.

FIG. 10 is a perspective cross-section view of a palm rest 900 for an electronic device that includes a sensor package 906, according to one embodiment of the disclosure. As shown, the palm rest 900 includes a thin film plastic layer 902 and injection molded plastic components 904. The thin film plastic layer 902 and injection molded plastic components 904 form a cavity into which a sensor package 906 is inserted. As shown in the example in FIG. 10, the sensor package 906 is coupled to the thin film plastic layer 902. Sensor electrodes can be included on the portion of the sensor package 906 coupled to the thin film plastic layer 902 to be driven with a capacitive sensing signal. While the figures, such as FIG. 10, illustrate a limited number of components in order to convey the underlying idea, it should be appreciated that a variety of other components may be included. For example, another material may be placed between the thin film plastic layer 902 and the injection molded plastic components 904 in some embodiments.

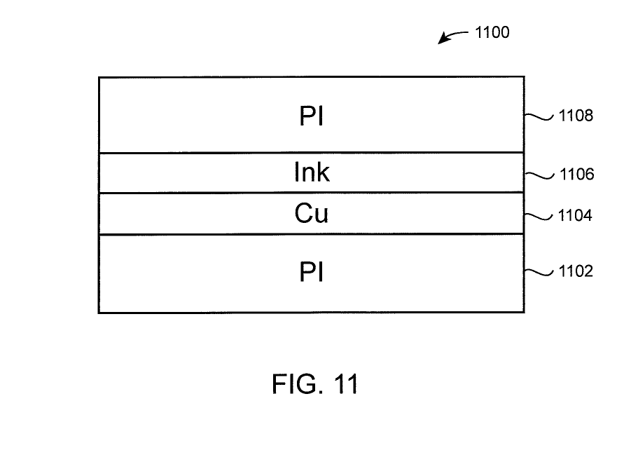

FIG. 11 is stackup 1100 of a COF (chip on flex) circuit that includes a thin film plastic layer, according to one embodiment of the disclosure. In some COF circuits, a first polyimide layer serves as a base onto which a copper layer of traces is deposited. A solder resist (SR) layer is then placed on top of the copper layer. The COF circuit can then covered by a protective covering, such as the IMD-manufactured thin film plastic layer described above.

In other embodiments, a COF (chip on flex) flex circuit itself can be the IMD layer. In these embodiments, the COF would not be bonded to the formed IMD layer, but rather is a part of the IMD film itself. As shown in the stackup 1100 of FIG. 11, a first polyimide layer 1102 serves as a base onto which a copper layer 1104 of traces is deposited. Then, instead of depositing a solder resist (SR) layer, an ink layer 1106 is provided that can be color coded to match a customer's requirements. A second polyimide layer 1108 is then added on top of the ink layer. The second polyimide layer 1108 is the layer that protects the ink layer 1106 from abrasion, ingress of water, etc. In the embodiment shown, this all-in-one IMD COF includes the second polyimide layer 1108, ink layer 1106, and copper layer 1104 thermoformed together. In one example implementation, the first polyimide layer 1102 has a thickness of about 25 microns, the copper layer has a thickness of about 8 microns, the ink layer 1106 has a thickness of about 10 microns, and the second polyimide layer 1108 has a thickness of about 25 microns. Other thickness amounts for the various layers shown in FIG. 11 are also within the scope of the present disclosure.

The embodiments and examples set forth herein were presented in order to best explain the present disclosure and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A capacitive sensing stackup, comprising:
a thin film plastic;
an injection molded plastic component bonded to the thin film plastic, wherein the injection molded plastic component forms a cavity bounded by the injection molded plastic and the thin film plastic that exposes at least a portion of the thin film plastic; and
a capacitive sensor assembly including a plurality of sensor electrodes configured to be driven with a capacitive sensing signal, wherein the capacitive sensor assembly is coupled to the thin film plastic in the cavity formed by the injection molded plastic component.

2. The capacitive sensing stackup of claim 1, wherein the injection molded plastic component is thicker than the thin film plastic.

3. The capacitive sensing stackup of claim 1, wherein the cavity includes two or more sides formed by the injection molded plastic component.

4. The capacitive sensing stackup of claim 1, wherein the capacitive sensing stackup comprises a button in a computing device.

5. The capacitive sensing stackup of claim 1, wherein the thin film plastic comprises a portion of the capacitive sensor assembly.

6. The capacitive sensing stackup of claim 1, wherein the thin film plastic has a thickness of 200 microns or less.

7. The capacitive sensing stackup of claim 1, wherein the thin film plastic includes one or more of ink and graphics.

8. The capacitive sensing stackup of claim 1, further comprising:
an illumination source, wherein light from the illumination source travels through the thin film plastic.

9. The capacitive sensing stackup of claim 1, wherein the thin film plastic is formed by a portion of an in-mold decoration (IMD) process.

10. The capacitive sensing stackup of claim 1, further comprising:
an adhesive configured to bond the capacitive sensor assembly to the thin film plastic in the cavity.

11. The capacitive sensing stackup of claim 1, wherein the capacitive sensor assembly comprises a fingerprint sensor.

12. A method for manufacturing a capacitive sensing stackup for capacitive sensing, the method comprising:
providing a thin film plastic;
injection molding an injection molded plastic component, wherein the injection molded plastic component is bonded to the thin film plastic, and wherein the injection molded plastic component forms a cavity bounded by the injection molded plastic component and the thin film plastic that exposes at least a portion of the thin film plastic; and
securing a capacitive sensor assembly including a plurality of sensor electrodes configured to be driven with a capacitive sensing signal to the thin film plastic, wherein the capacitive sensor assembly is coupled to the thin film plastic in the cavity formed by the injection molded plastic component.

13. The method of claim 12, further comprising:
pressing the thin film plastic into a shape.

14. The method of claim 13, further comprising:
adding one or more of ink and graphics to the thin film plastic prior to pressing the thin film plastic into the shape.

15. The method of claim 12, wherein the cavity includes two or more sides formed by the injection molded plastic component.

16. The method of claim 12, wherein the thin film plastic has a thickness of 200 microns or less.

17. The method of claim 12, wherein providing the thin film plastic comprises forming the thin film plastic by a portion of an in-mold decoration (IMD) process.

18. The method of claim 12, wherein the capacitive sensor assembly comprises a fingerprint sensor.

19. A mobile computing device, comprising:
a housing body; and
a capacitive sensing stackup embedded in the housing body, comprising:
a thin film plastic,
an injection molded plastic component bonded to the thin film plastic, wherein the injection molded plastic component forms a cavity bounded by the injection molded plastic and the thin film plastic that exposes at least a portion of the thin film plastic, and
a capacitive sensor assembly including a plurality of sensor electrodes configured to be driven with a capacitive sensing signal, wherein the capacitive sensor assembly is coupled to the thin film plastic in the cavity formed by the injection molded plastic component.

20. The mobile computing device of claim 19, wherein the thin film plastic comprises a portion of the capacitive sensor assembly.

21. The mobile computing device of claim 19, wherein the mobile computing device comprises a mobile phone, and wherein the capacitive sensing stackup is embedded in a button of the mobile phone.
